(19) United States
(12) Patent Application Publication
(10) Pub. No.: US 2011/0137518 A1
(43) Pub. Date: Jun. 9, 2011

(54) EXECUTION DEVICE, EXECUTION METHOD AND EXECUTION SYSTEM WHICH ALLOW VARIOUS ON-BOARD DEVICES TO EXECUTE ACTIONS REQUIRING USER AGREEMENT AND COMMUNICATION CENTER WHICH CONSTITUTES EXECUTION SYSTEM, AND ON-BOARD DEVICE WHICH EXECUTES ACTION REQUIRING USER AGREEMENT

(75) Inventor: Toshiyuki Abe, Aichi-ken (JP)

(73) Assignee: TOYOTA JIDOSHA KABUSHIKI KAISHA, Toyota-shi, Aichi-ken (JP)

(21) Appl. No.: 13/055,018

(22) PCT Filed: Jul. 24, 2009
(86) PCT No.: PCT/IB2009/006339

§ 371 Date: Jan. 20, 2011

(30) Foreign Application Priority Data
Jul. 25, 2008 (JP) 2008-192394

(51) Int. Cl. G06F 19/00; G01M 17/00

(52) U.S. Cl. 701/35; 701/1

(57) ABSTRACT

An agreement requiring action execution device, which allows an on-board device to execute an agreement requiring action, has an agreement necessity determination section; an agreement prompt section; an agreement confirmation section; and an execution section. The agreement necessity determination section determines whether or not agreement of the user is required to allow a specific agreement requiring action to be executed as it identifies the laws or the like that apply now based on the location of the vehicle. If it is determined that agreement of the user is required to execute the specific agreement requiring action, the agreement prompt section displays a screen G or outputs sound guidance which prompts the user to decide whether to agree or disagree. When the agreement confirmation section confirms agreement of the user, the execution section allows the on-board device to execute the specific action.

### BACKGROUND OF THE INVENTION

1. Field of the Invention

The present invention relates to an execution device that executes an action requiring the agreement of the user to execute (which is hereinafter referred to as “agreement requiring action”).

The present invention also relates to an execution method and an execution system that allow various on-board devices to execute agreement requiring actions, a communication center that constitutes the execution system, and an on-board device that executes an agreement requiring action.

2. Description of the Related Art

Electronic control devices for vehicles are known that record data necessary to reproduce a malfunction or identification of defect location (see Japanese Patent Application Publication No. 2000-145533 (JP-A-2000-145533), for example).

However, because the electronic control device described in JP-A-2000-145533 records even data by which an individual can be identified, such as the information concerning the location of the vehicle, without obtaining the agreement of the user of the vehicle, the recording action may be improper when recording the data is an agreement requiring action.

It may be possible to obtain the user's agreement to execute all the actions that may be agreement requiring actions when a vehicle is sold, but to obtain such agreement when the user has no specific necessity to decide whether to agree may be problematic.

### SUMMARY OF THE INVENTION

The present invention provides an agreement requiring action execution device, an agreement requiring action execution method, and an agreement requiring action execution system which allow an action that requires agreement of the user to execute to be executed upon obtaining agreement of the user, and a communication center which constitutes the execution system, and an on-board device which executes an action that requires agreement of the user.

A first aspect of this invention is an agreement requiring action execution device that allows an on-board device to execute an action that requires agreement of the user to execute the action. The agreement requiring action execution device includes: a criteria storage section; an agreement necessity determination section, an agreement prompt section; an agreement confirmation section; and an execution section. The criteria storage section stores criteria for agreement, which specify the conditions under which agreement of the user is required in order for the on-board device to execute the action. The agreement necessity determination section checks the criteria for agreement to determine whether agreement of the user is required in order for the on-board device to execute the action. The agreement prompt section prompts the user to decide whether to agree or disagree when it is determined that agreement of the user is required for the execution of the action in the on-board device. The agreement confirmation section confirms the agreement or disagreement of the user. The execution section allows continuation or initiation of the action in the on-board device when the user agreement is confirmed.

In the agreement requiring action execution device of the first aspect, when it is determined that the on-board device requires the user agreement to execute the action, the agreement prompt section may display a terms-of-agreement text corresponding to the action in a screen and/or output the terms-of-agreement text as sound guidance to prompt the user to decide whether to agree or disagree.

The agreement requiring action execution device of the first aspect may be installed in a vehicle or in the on-board device.

In the first aspect, the agreement necessity determination section may determine whether the user agreement is required in order for the on-board device to execute the action by checking whether or not the criteria for agreement are satisfied based on the location of the vehicle or time and date.

In the first aspect, the agreement requiring action may be recording of a data by a diagnostic recorder or a trip recorder.

The execution section may prohibit the execution of the action in the on-board device if the disagreement of the user is confirmed.

The agreement requiring action may be an action that the on-board device is in the process of executing or the on-board device is about to execute.

In the first aspect, the criteria for agreement may further include a criteria change detection section that detects whether any of the criteria for agreement have been changed. When the criteria change detection section detects that any of the criteria for agreement have been changed, the agreement necessity determination section may determine whether agreement of the user is required in order for the on-board device to execute the action.

A second aspect of the present invention is an agreement requiring action execution method to allow an on-board device to execute an action that requires agreement of the user to execute the action. The execution method includes: storing criteria for agreement that specify the conditions under which agreement of the user is required in order for the on-board device to execute the action; checking the criteria for agreement to determine whether agreement of the user is required when the action is executed in the on-board device; prompting the user to decide whether to agree or disagree if it is determined that agreement of the user is required in order for the on-board device to execute the action; confirming the agreement or disagreement of the user; and allowing continuation or initiation of the action in the on-board device when the user agreement is confirmed.

An agreement requiring action execution system according to a third aspect of this invention includes: an agreement requiring action execution device that is installed in a vehicle; and a communication center that communicates with the agreement requiring action execution device. The communication center includes: a storage section that stores criteria for agreement, which specify the conditions under which agreement of the user is required in order for the on-board device to execute the action; and a first communication section that communicates with the agreement requiring action execution device. The agreement requiring action execution device includes: a second communication section that communicates with the communication center; an agreement necessity determination section that checks the criteria for agreement in the communication center, via the second communication section, to determine whether agreement of the user is required in order for the on-board device to execute the action; an agreement prompt section that reads out a terms-of-agreement text corresponding to the action from the communication center, causes an on-board output device to display the terms-of-agreement text or output the terms-of-agreement text as sound guidance and that prompts the user to decide whether to agree or disagree, if it is determined that agreement of the user is required; an agreement confirmation section that confirms the agreement or disagreement of the user via an on-board input device; and an execution section that allows the action in the on-board device to continue or initiate when the user agreement is confirmed.

In the third aspect, the storage section in the communication center may further include: a database that stores criteria for agreement specifying the conditions under which agreement of the user is required in order for the on-board device to execute the action; and a database that stores the user agreement history.

In accordance with the above aspects, the present invention can provide an agreement requiring action execution device, an agreement requiring action execution method, and an agreement requiring action execution system which allow an action that requires agreement of the user to execute to be executed upon obtaining agreement of the user, a communication center which constitutes an agreement requiring action execution system, and an on-board device which executes an agreement requiring action.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a block diagram that illustrates an example of the configuration of an agreement requiring action execution device according to a first embodiment of the present invention;

FIG. 2 is a view that illustrates an example of the configuration of a decision prompt screen;

FIG. 3 is a flowchart that shows the flow of an agreement requiring action continuation process;

FIG. 4 is a flowchart that shows the flow of an agreement requiring action initiation process;

FIG. 5 is a block diagram that illustrates an example of the configuration of an agreement requiring action execution system according to a second embodiment of the present invention; and

FIG. 6 is a block diagram that illustrates an example of the configuration of an agreement requiring action execution system according to a modification of the present invention.

### DETAILED DESCRIPTION OF EMBODIMENTS

Description is hereinafter made of embodiments to implement the present invention with reference to the drawings.

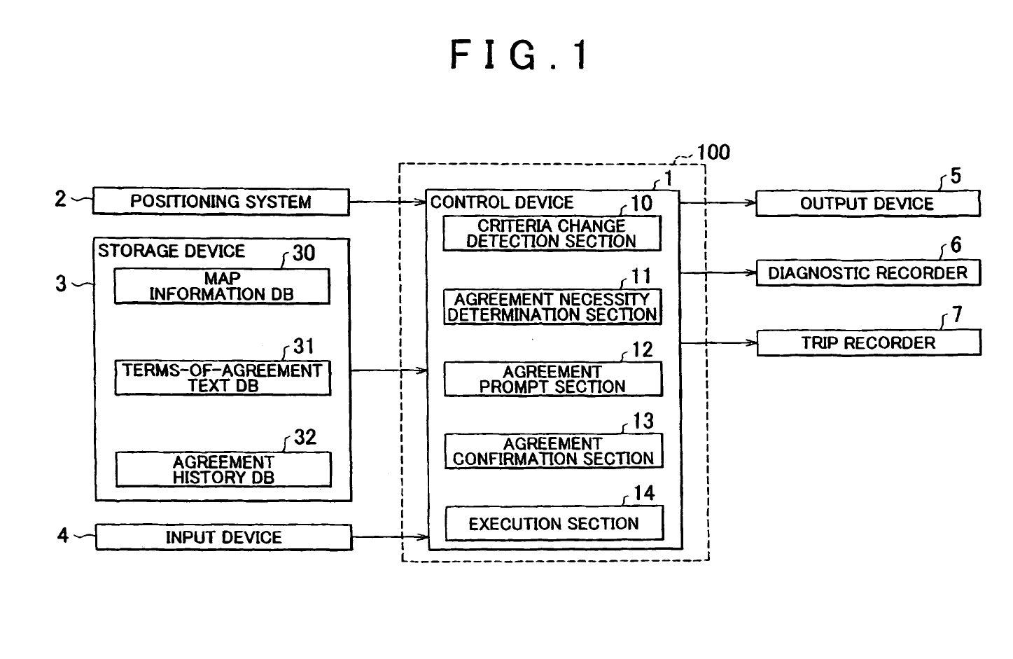

FIG. 1 is a block diagram that illustrates an example of the configuration of an agreement requiring action execution device according to a first embodiment of the present invention. An agreement requiring action execution device 100 is an on-board device that allows various on-board devices to execute actions that are required by the laws, regulations or the like of a particular jurisdiction to obtain the agreement of the user before the particular action may be executed. The agreement requiring action execution device 100 includes a control device 1 and is connected to a positioning system 2, a storage device 3, an input device 4, an output device 5, a diagnostic recorder 6 and a trip recorder 7 via an onboard LAN such as a CAN (Controller Area Network) or LIN (Local Interconnect Network).

The control device 1 is a computer that includes a CPU (Central Processing Unit), a RAM (Random Access Memory), a ROM (Read Only Memory), and so on. The control device 1 also includes a criteria change detection section 10, an agreement necessity determination section 11, an agreement prompt section 12, an agreement confirmation section 13, and an agreement requiring action execution section 14, for example. Each program that is executed by each section is stored in the ROM.

The positioning system 2, which determines the location of a vehicle, receives a GPS (Global Positioning System) signal output from a GPS satellite with a GPS receiver via a GPS antenna and measures the location (latitude, longitude and altitude) of the vehicle based on the received signal, for example.

The storage device 3, which stores various information, is composed of a storage medium such as a hard drive or digital versatile disk (DVD) and includes a map information database 30 (which is hereinafter referred to as “map information DB 30”), a terms-of-agreement text database 31 (which is hereinafter referred to as “terms-of-agreement text DB 31”) and an agreement history database 32 (which is hereinafter referred to as “agreement history DB 32”).

The map information DB 30 is a database in which the locations of nodes such as intersections and interchanges, the distances of links (paths that connect nodes), the link costs (degrees of time and cost necessary to pass each link), the locations (latitude, longitude and altitude) of facilities, the names of facilities, and so on are systemically stored. In addition, information regarding administrative districts such as countries, states and prefectures (corresponding to jurisdictions where laws and so on apply) are included in the stored information.

Criteria for agreement, which specify the conditions under which agreement of the user is required for the execution of various actions in various on-board devices, are stored in the terms-of-agreement text DB 31. Furthermore, the terms-of-agreement text DB 31 stores, for example, information concerning application of laws and so on (for example, the periods during which the laws are in force and the scope of application of the laws) and information concerning the agreement requiring actions regulated by the laws and so on in relation to terms-of-agreement texts each corresponding to an agreement requiring action. The terms-of-agreement texts for each of the agreement requiring actions or each jurisdiction (for example, each of the countries or administrative districts) where the laws and so on in which the agreement requiring actions are regulated apply are also stored in the terms-of-agreement text DB 31. The terms-of-agreement texts are prepared for each of the laws and so on so that they meet the requirements of a corresponding law or the like, and are stored as text data or image data. The terms-of-agreement text DB 31 may store the terms-of-agreement texts in relation to the information concerning the periods of validity (the date of enforcement or the expiration date) of the laws and so on.

The terms-of-agreement texts may respectively correspond to a plurality of agreement requiring actions and be different for each applicable jurisdiction, or terms-of-agreement texts may respectively correspond to a plurality of applicable jurisdictions and be different for each of the agreement requiring actions.

The laws and so on include “Act on the Protection of Personal Information” in Japan, “EU Data Protection Directive 95/46/EC” in the European Union, and so on.

The agreement requiring actions include recording of data by which an individual may be identified, data by which personal activities may be identified and data on personal privacy and reading out such data, such as recording the location of the vehicle output from the positioning system 2.

The agreement requiring actions also include video recording, audio recording, paying a certain amount of money, uploading the data that the vehicle has collected as a probe car and so on.

The agreement history DB 32 keeps records of agreements the user has made, and records the fact that the user made an agreement in relation to the time and date when the agreement was made, the agreement requiring action, and the applicable jurisdiction, for example.

The input device 4, which is used to input various information into the control device 1, includes a touch panel, joystick, remote controller or escutcheon button for manual input, or a microphone for voice input, for example, and is used to input the intention to agree to or disagree with the execution of an agreement requiring action.

The output device 5, which enables the user to recognize various information output from the control device 1, has a liquid crystal display or on-board loudspeaker, for example, and displays a screen that prompts the user to agree to the execution of an agreement requiring action or outputs sound guidance which prompts the user to agree to the execution of an agreement requiring action.

The diagnostic recorder 6, which records data which can be used for failure diagnosis of the vehicle, records the values themselves of data output from various on-board devices such as engine rotational speed, vehicle speed, coolant temperature and oil temperature when the data meet a specific condition or records the fact that data meet a specific condition (an abnormal state has occurred) as an identification number together with the time of occurrence.

The trip recorder 7, which records the data on the operation of the vehicle continuously, records, for example, image data captured by an on-board camera or audio data collected by a microphone disposed in the passenger compartment when the user brakes suddenly in addition to the data output from the various on-board device as described above.

The various sections that the control device 1 has are described next.

The criteria change detection section 10, which detects whether the criteria for agreement have changed, detects whether or not the applicable laws and so on have changed based on the output from the positioning system 2, and the map information DB 30 and the terms-of-agreement text DB 31 stored in the storage device 3, for example.

The criteria change detection section 10 may detect whether the applicable laws and so on have changed based on the time information output from a timer in the control device 1 and the information concerning the expiration dates of laws and so on stored in the terms-of-agreement text DB 31.

In addition, the criteria change detection section 10 outputs a control signal to the output device 5 to cause it to display a screen that informs the user via the liquid crystal display or cause it to output a voice message that informs the user via the on-board loudspeaker when changes in the applicable laws and so on are detected.

The agreement necessity determination section 11 checks the criteria for agreement and determines whether agreement of the user is necessary, and, if the criteria change detection section 10 detects that the applicable laws and so on have changed, determines whether agreement of the user is required for the execution of various actions in various on-board devices according to the new applicable laws and so on, for example.

For example, if it is determined that the vehicle has crossed the border between jurisdictions (for example, national border, state border, prefectural border, etc.) and various on-board devices have been executing specific agreement requiring actions registered in the terms-of-agreement text DB 31, or if the vehicle has entered a jurisdiction where laws or the like including a provision that agreement of the user is required for the execution of specific actions apply and various on-board devices are about to start the execution of the specific actions, the agreement necessity determination section 11 determines that agreement of the user is required to allow the various on-board devices to execute the specific actions.

Also, if actions which were not agreement requiring actions become agreement requiring actions because of the implementation of new laws or the like when various on-board devices are executing the actions, or if various on-board devices execute actions which were not agreement requiring actions but have become agreement requiring actions because of the implementation of new laws or the like for the first time after the date of implementation of the laws, the agreement necessity determination section 11 determines that agreement of the user is required to allow the various on-board devices to execute the agreement requiring actions.

If the agreement necessity determination section 11 determines that an action which previously required agreement of the user to execute no longer requires the user's agreement because the vehicle has exited the jurisdiction where a law or the like applies or that a law or the like has expired, the agreement necessity determination section 11 may output a control signal to the output device 5 to inform the user that his or her agreement is no longer required to execute the particular action via a screen display on the liquid crystal display or via a voice message from the on-board loudspeaker.

The agreement prompt section 12 prompts the user to decide whether or not to agree to the execution of specific actions by various on-board devices. For example, if the agreement necessity determination section 11 determines that agreement of the user is required to allow a specific agreement requiring action to be executed, the agreement prompt section 12 outputs a control signal to the output device 5 while it checks the criteria for agreement stored in the terms-of-agreement text DB 31 to cause it to display a screen to prompt the user to decide whether to agree or not to the execution of the specific agreement requiring action (which is hereinafter referred to as “decision prompt screen”) on the liquid crystal display or cause it to read out the content of the terms-of-agreement text for the agreement requiring action and output a voice message to prompt the user to decide whether to agree or not (which is hereinafter referred to as “decision prompt voice message”) from the on-board loudspeaker.

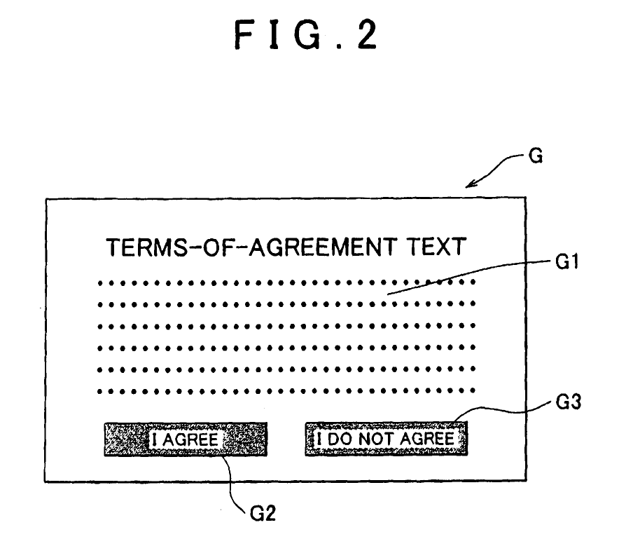

FIG. 2 is a view that illustrates an example of the configuration of the decision prompt screen. A decision prompt screen G is a screen that is displayed by the output device 5, and is composed of a text section G1 showing the content of a terms-of-agreement text, an agreement button G2, and a disagreement button G3.

The agreement confirmation section 13 confirms the intention of the user to agree or disagree. For example, the agreement confirmation section 13 activates the agreement button G2 and the disagreement button G3 (makes the agreement button G2 and the disagreement button G3 pressable) after a predetermined period of time has passed from when the decision prompt screen G starts to be displayed, and confirms that the user agrees with the content of the terms-of-agreement text displayed in the text section G1 if it detects that the agreement button G2 was pressed and confirms that the user does not agree with the content of the terms-of-agreement text if it detects that the disagreement button G3 was pressed.

In order to prevent the user from deciding to agree or disagree without understanding the content of the terms-of-agreement text as much as possible, the agreement button G2 and the disagreement button G3 are not activated until after a predetermined period of time has passed from when display of the decision prompt screen G is started.

Similarly, the agreement confirmation section 13 activates the agreement button G2 and the disagreement button G3 after the decision prompt voice message is completely output, and confirms that the user agrees with the content of the terms-of-agreement text displayed in the text section G1 if it detects that the agreement button G2 was pressed and confirms that the user does not agree with the content of the terms-of-agreement text if it detects that the disagreement button G3 was pressed.

The agreement confirmation section 13 may determine that the user does not agree to the execution of the agreement requiring action if the user has refrained from indicating agreement or disagreement for a predetermined period of time after display of the decision prompt screen G is started or the decision prompt voice message is completely output. This is because the intention of the user to disagree may be inferred.

The agreement confirmation section 13 may cause the decision prompt screen G to be displayed continuously or the decision prompt voice message to be periodically repeated until the user indicates his or her agreement or disagreement (until the user makes an input into the input device 4) if the user has not decide whether to agree or disagree for a predetermined period of time. Alternatively, the agreement confirmation section 13 may suspend the determination of the user agreement or disagreement until the user decides whether to agree or disagree.

Once the agreement confirmation section 13 has confirmed the user's agreement or disagreement, it stores the result in the agreement history DB 32 of the storage device 3. The reason for this is to make it possible for the agreement confirmation section 13 to consult the history so that the user's agreement is not requested again if the user's agreement or disagreement has already been confirmed and is deemed valid in accordance with legal requirements.

For example, if the agreement confirmation section 13 consults the agreement history DB 32 before the agreement prompt section 12 outputs the decision prompt screen G or the decision prompt voice message and confirms that the user has previously indicated his or her agreement and the previously indicated agreement is still deemed valid, the agreement confirmation section 13 deems that agreement to the agreement requiring action in question has already been made without outputting the decision prompt screen G or the decision prompt voice message. A similar procedure is involved if it is confirmed that an intention to disagree has been indicated.

The execution section 14 allows various on-board devices to execute actions that require the agreement of the user to execute. For example, if the agreement necessity determination section 11 determines that agreement of the user is required to execute specific agreement requiring actions and if the agreement confirmation section 13 confirms the user's agreement, the execution section 14 allows various on-board devices to continue or start the specific agreement requiring actions.

Also, if the agreement necessity determination section 11 determines that agreement of the user is required to execute specific agreement requiring actions and if the agreement confirmation section 13 confirms the user's disagreement, the agreement requiring action execution section 14 causes various on-board devices to stop the specific agreement requiring actions or prohibits various on-board devices from starting the specific agreement requiring actions.

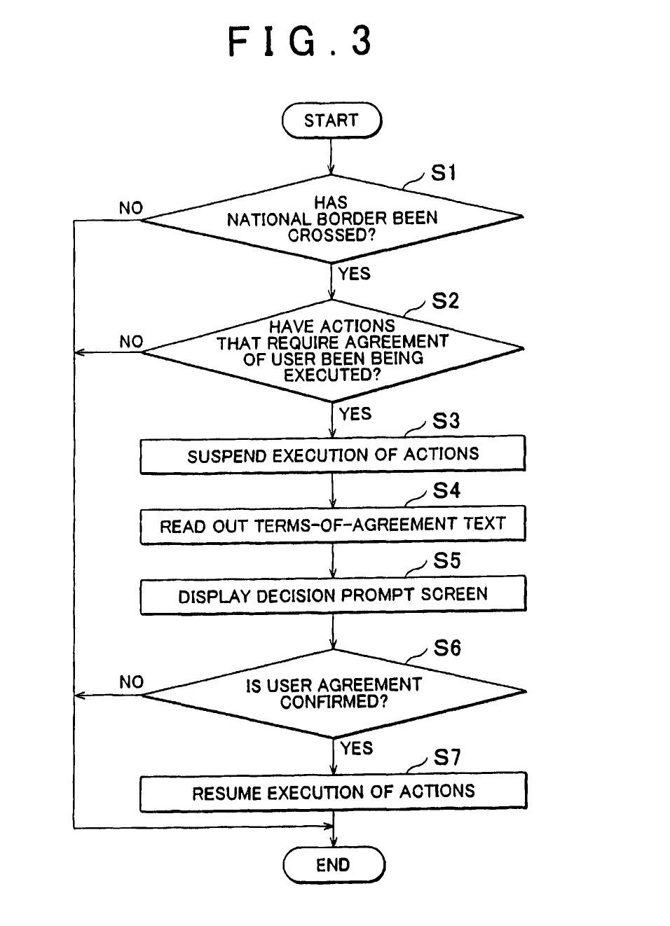

Referring next to FIG. 3, the process performed by the agreement requiring action execution device 100 to allow the diagnostic recorder 6 to continue to record positional information (which is hereinafter referred to as “agreement requiring action continuation process”) when the vehicle enters Country A, where the agreement of the driver is a legal requirement for recording positional information.

FIG. 3 is a flowchart that shows the flow of the agreement requiring action continuation process. The following description is based on the assumption that the diagnostic recorder 6 of the vehicle has been recording positional information since before the vehicle enters Country A.

First, the control device 1 of the agreement requiring action execution device 100 monitors the crossing of the vehicle across a national border based on the output from the positioning system 2 (step S1).

Unless the vehicle crosses a national border (if NO in step S1), the control device 1 ends the routine. This is because the applicable laws remain the same (any agreement requiring actions that require agreement to execute are not being executed).

If the fact that the vehicle has crossed a national border and entered Country A is detected (YES in step S1), the agreement necessity determination section 11 of the control device 1 determines whether any agreement requiring actions according to the laws of Country A, which are newly applied, have been executed in the vehicle with reference to the terms-of-agreement text DB 31 of the storage device 3 (step S2: agreement necessity determining step).

If any agreement requiring actions have not been executed in the vehicle (NO in step S2), the control device 1 ends the routine.

If any agreement requiring actions have been already executed in the vehicle (YES in step S2), the control device 1 suspends the agreement requiring actions (step S3).

In this case, because recording of positional information by the diagnostic recorder 6 is defined as an agreement requiring action in accordance with the legal requirements in Country A, the control device 1 suspends the recording of positional information by the diagnostic recorder 6. The control device 1 may allow the diagnostic recorder 6 to continue recording the positional information even after the vehicle has crossed the national border on condition that the information will be retroactively deleted if agreement of the user is not obtained. The reason for this is that if it takes long time to obtain agreement of the user, the deletion of the data obtained during that period may undermine the intended purpose of the diagnostic recorder 6, detection of a malfunction.

After that, the agreement prompt section 12 of the control device 1 reads out the corresponding terms-of-agreement text stored in the terms-of-agreement text DB 31 (step S4), and causes the output device 5 (the on-board liquid crystal display) to display the decision prompt screen G (see FIG. 2) to prompt the user to decide whether to agree or not (step S5: agreement prompting step).

In this case, the terms-of-agreement text preferably includes only the terms of agreement regarding the recording of positional information by the diagnostic recorder 6, but may include terms of agreement regarding other agreement requiring actions as long as the legal requirements of Country A are satisfied.

Then, the agreement confirmation section 13 of the control device 1 activates the agreement button G2 and the disagreement button G3 after a predetermined period of time has passed after the decision prompt screen G is displayed, and waits until the agreement button G2 or the disagreement button G3 is pressed through the input device 4 (step S6: agreement confirming step).

If the disagreement button G3 is pressed (NO in step S6), the control device 1 terminates the agreement requiring action continuation process without resuming the suspended agreement requiring actions. This is to comply with the legal requirements in Country A.

In this case, the control device 1 prohibits the diagnostic recorder 6 from recording positional information, and deletes the positional information retroactive to the time when the vehicle crossed the national border if the diagnostic recorder has been recording positional information even after the vehicle crossed the national border.

If the agreement button G2 is pressed (YES in step S6), the agreement requiring action execution section 14 of the control device 1 allows the suspended agreement requiring action to resume (step S7: agreement requiring action executing step).

In this case, the agreement requiring action execution section 14 of the control device 1 outputs a control signal to the diagnostic recorder 6 to allow the diagnostic recorder 6 to resume recording positional information.

If the agreement confirmation section 13 of the control device 1 confirms that it has obtained agreement on recording of positional information in Country A from the user in the past (on the same day, for example) by consulting the agreement history DB 32, the control device 1 may allow the diagnostic recorder 6 to continue recording the positional information without interruption by reconfirming whether or not the user has agreed.

The control device 1 may cause the decision prompt screen G to be displayed to prompt the user to decide whether to agree whenever the occasion arises even if it has obtained agreement of the user in the past (even while the decision made in the past is deemed as valid).

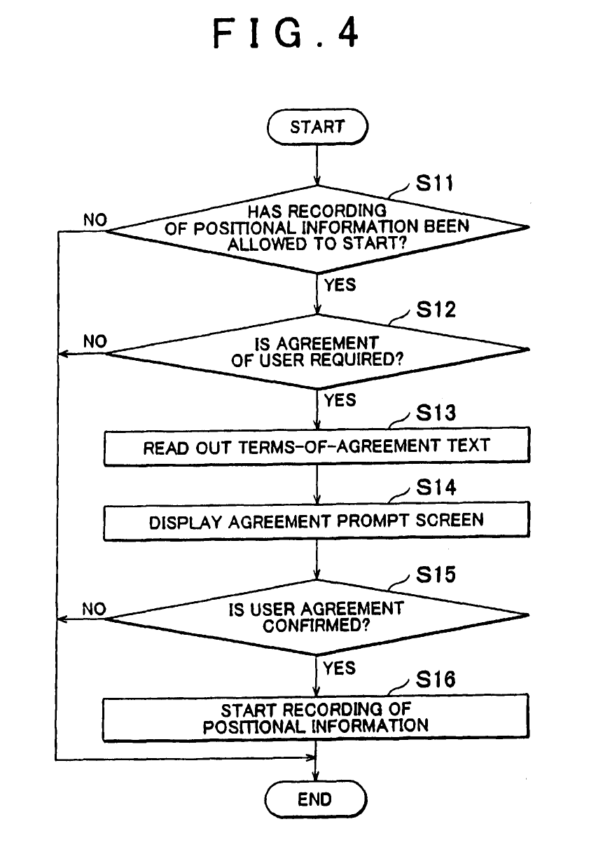

Referring next to FIG. 4, description is made of processing which the agreement requiring action execution device 100 performs to allow the trip recorder 7 to start recording of positional information (which is hereinafter referred to as “agreement requiring action initialization”) when the vehicle is traveling in Country A where the driver's agreement is legally required before positional information may be recorded.

FIG. 4 is a flowchart that shows the flow of the agreement requiring action initiation process. The following description is based on the assumption that the trip recorder 7 of the vehicle has not started recording positional information.

First, the control device 1 monitors the execution of an operation to allow the trip recorder 7 to start recording of positional information (including a manual operation the user performs via the input device 4 on his or her own will and automatic operations by various on-board devices) (step S11).

Unless an operation to allow the trip recorder 7 to start recording of positional information is not performed (NO in step S11), the control device 1 skips the execution of the subsequent steps. This is because there is no need to obtain agreement of the user.

If the fact that an operation to allow the trip recorder 7 to start recording of positional information has been performed is detected (YES in step S11), the agreement necessity determination section 11 of the control device 1 determines whether the action that is about to be executed is an action that requires agreement of the user under the laws of Country A by referring reference to the terms-of-agreement text DB 31 of the storage device 3 (step S12: agreement necessity determining step).

If the action that is about to be executed is not an action that requires agreement of the user under the laws of Country A (NO in step S12), the control device 1 skips the execution of the subsequent steps.

If the action that is about to be executed requires agreement of the user under the laws of Country A (YES in step S12), the agreement prompt section 12 of the control device 1 reads out a corresponding terms-of-agreement text stored in the terms-of-agreement text DB 31 (step S13), and causes the output device 5 (on-board loudspeaker) to output the decision prompt voice message to prompt the user to decide whether to agree (step S14: agreement prompting step).

After that, the agreement confirmation section 13 of the control device 1 activates the agreement button G2 and the disagreement button G3 displayed on the liquid crystal display when the decision prompt voice message is completely output, and waits until the agreement button G2 or the disagreement button G3 is pressed via the input device 4 (step S15: agreement confirming step).

If the disagreement button G3 is pressed (NO in step S15), the control device 1 terminates the agreement requiring action continuation process without allowing the trip recorder 7 to start recording of positional information. The reason for this is to comply with the laws of Country A.

If the agreement button G2 is pressed (YES in step S15), the agreement requiring action execution section 14 of the control device 1 allows the trip recorder 7 to start recording of positional information (step S16: agreement requiring action executing step).

In this case, the agreement requiring action execution section 14 of the control device 1 outputs a control signal to the trip recorder 7 to allow the trip recorder 7 to start recording the positional information.

If the agreement confirmation section 13 of the control device 1 confirms that it has previously obtained agreement from the user to record positional information in Country A (on the same day, for example) by consulting the agreement history DB 32, the control device 1 may allow the trip recorder 7 to start recording positional information immediately without outputting the decision prompt voice message from the on-board loudspeaker.

The control device 1 may output the decision prompt voice message to prompt the user to decide whether to agree whenever the occasion arises, even if it has obtained agreement from the user in the past.

With the above configuration, even if applicable laws or the like change with movement of the vehicle or laws are amended with passage of time, the agreement requiring action execution device 100 allows agreement requiring actions to be executed upon obtaining agreement of the user.

Also, the agreement requiring action execution device 100 may allow various on-board devices to operate in compliance with legal requirements even if a vehicle is used in an environment in which it frequently crosses national borders or state borders and the applicable laws or the like frequently change.

While the agreement requiring action execution device 100 allows on-board devices such as the diagnostic recorder 6 and the trip recorder 7 to execute agreement requiring actions upon obtaining agreement of the user, the on-board devices such as the diagnostic recorder 6 and the trip recorder 7 may have the criteria change detection section 10, the agreement necessity determination section 11, the agreement prompt section 12, the agreement confirmation section 13 and the agreement requiring action execution section 14 of their own and execute the agreement requiring actions upon obtaining agreement of the user independently.

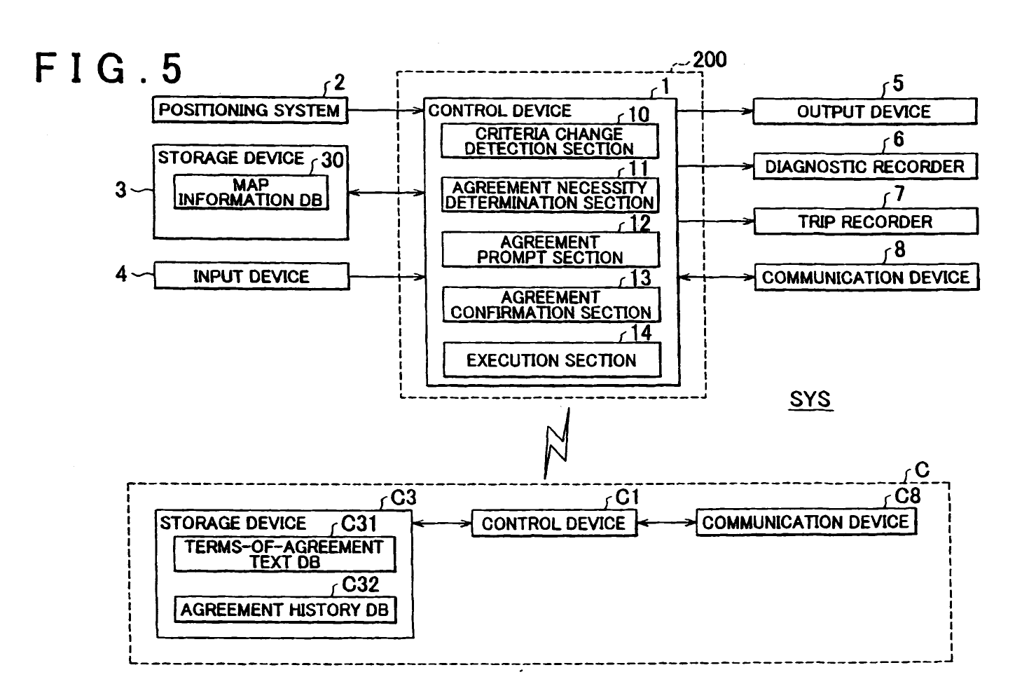

FIG. 5 is a block diagram that illustrates an example of the configuration of an agreement requiring action execution system according to a second embodiment of the present invention. An agreement requiring action execution system SYS is a system that is includes an agreement requiring action execution device 200 that allows various on-board devices to execute agreement requiring, and a communication center C.

The agreement requiring action execution device 200, which is a device provided in the vehicle, is the same as the agreement requiring action execution device 100 except that it is connected to a communication device 8. Therefore, the same reference numerals are used to designate the common constituent elements.

The communication device 8 controls the communication with the communication center C, and communicates with the communication center C using frequencies for cellular devices, for example.

The communication center C is installed in a fixed facility, and has a control device C1, which is a computer having a CPU, a RAM, a ROM and so on, a storage device C3 in which a terms-of-agreement text DB (C31) and an agreement history DB (C32) are stored, and a communication device C8 that controls the communication with the communication device 8.

The agreement requiring action execution device 200 confirms, every time the vehicle crosses a national border or the date changes, whether there are any agreement requiring actions that require agreement of the user in the laws or the like of the country the vehicle has entered with reference to the terms-of-agreement text DB (C31) included in the storage device C3 of the communication center C via communication, and, if there are any agreement requiring actions and if any of the agreement requiring actions are already being executed in the vehicle, reads out the terms-of-agreement texts corresponding to the agreement requiring actions from the terms-of-agreement text DB (C31) and causes them to be displayed on the output device 5 or to be output as sound guidance.

Also, the agreement requiring action execution device 200 confirms, every time it allows various on-board devices to start specific actions, whether agreement of the user is required to start the specific actions in accordance with the legal requirements of the country in which the vehicle is traveling with reference to the terms-of-agreement text DB (C31) stored in the storage device C3 via communication, and, if agreement is required, reads out the terms-of-agreement texts corresponding to the agreement requiring actions from the terms-of-agreement text DB (C31) and causes them to be displayed on the output device 5 or to be output as sound guidance.

Also, the agreement requiring action execution device 200 stores the result of the user's decision whether to agree or disagree in the agreement history DB (C32) in the storage device C3 of the communication center C.

In addition, every time the vehicle crosses a national border, the date changes, or the agreement requiring action execution device 200 allows various on-board devices to start specific actions, the agreement requiring action execution device 200 confirms whether the user has agreed to the execution of the actions by referring to the agreement history DB (C32) stored in the storage device C3 of the communication center C via communication, and allows the actions to be continued or started without reconfirming whether the user agrees if the user has already agreed.

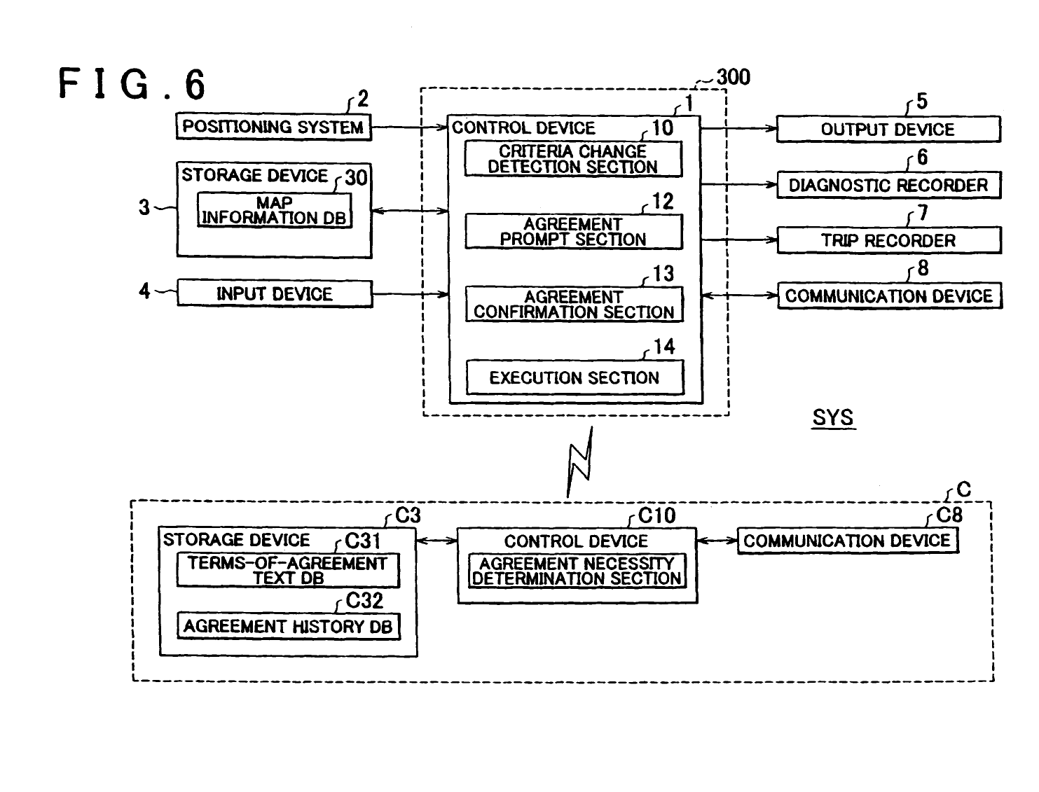

While, in the agreement requiring action execution system SYS described in the preceding embodiment, the criteria change detection section 10, the agreement necessity determination section 11, the agreement prompt section 12, the agreement confirmation section 13 and the agreement requiring action execution section 14 are provided in the control device 1 of the agreement requiring action execution device 200, one or more of the section 10 to the section 14 may also be provided in the control device C1 of the communication center C. For example, the control device C10 in the communication center C may determine whether the actions that various on-board devices are about to execute are actions that require agreement of the user, as shown in FIG. 6. This is to enable the communication center C to manage all the processes involving compliance with legal requirements, that is, agreement about the execution of agreement requiring actions.

With the above configuration, in the agreement requiring action execution system SYS, because the terms-of-agreement text DB (C31) is managed in the communication center C, there is no need to provide the terms-of-agreement text DB 31 in each vehicle as in the case of the agreement requiring action execution device 100, and the terms-of-agreement text DB (C31) may be always kept up-to-date and therefore a quick and appropriate response may be made even if any legal requirements are amended.

Also, in the agreement requiring action execution system SYS, because the agreement history DB (C32) is managed in the communication center C, falsification of agreement history by the user or loss of agreement history caused by a vehicle accident may be prevented reliably.

While various embodiments of the present invention have been described, the present invention is not limited to the described embodiments and various modifications and substitutions may be made in the embodiments described above without departing from the scope of the present invention.

For example, although the agreement requiring action execution device 100 or 200 causes the decision prompt screen G to be displayed or the decision prompt voice message to be output immediately after the vehicle crosses a national border or the date changes in the above embodiments, the display or sound output may be postponed until the vehicle comes to a halt or the vehicle speed falls below a threshold value.

The reason for this is to avoid distracting the user by requiring the user to decide whether to agree during driving, and to avoid disrupting the display or guidance of navigation information (map information). Another reason for this is that it is possible to make the user understand the content of the terms-of-agreement text more fully when the decision prompt screen G is displayed or the decision prompt voice message is output when the vehicle is stopped.

In addition, if the user restarts the vehicle without indicating agreement or disagreement, the display of the decision prompt screen G or the output of the decision prompt voice message may be postponed again until the vehicle comes to a halt next time. Even in such a case, the execution of agreement requiring actions is suspended and start of agreement requiring actions is postponed until agreement of the user is obtained. The reason for this is to comply with legal requirements.

In the described embodiments, although the liquid crystal display or the on-board loudspeaker is used as the output device 5, these are not limited. Seat vibration may prompt the user to decide whether to agree or disagree to execute the action that requires agreement of the user, or the combination at least two of display, on-board loudspeaker, seat vibration and so on may prompt the user to decide whether to agree or disagree.

1. An agreement requiring action execution device that allows an on-board device to execute an action that requires agreement of a user to execute the action, the agreement requiring action execution device comprising:
a criteria storage section that stores criteria for agreement, which specify the conditions under which agreement of the user is required in order for the on-board device to execute the action;
an agreement necessity determination section that checks the criteria for agreement to determine whether agreement of the user is required in order for the on-board device to execute the action;
an agreement prompt section that prompts the user to decide whether to agree or disagree when it is determined that the on-board device requires the user agreement to execute the action;
an agreement confirmation section that confirms the agreement or disagreement of the user; and
an execution section that allows the action executed in the on-board device to continue or to initiate when the user agreement is confirmed.

2. The agreement requiring action execution device according to claim 1,
wherein, when it is determined that the on-board device requires the user agreement to execute the action, the agreement prompt section performs at least one of a display of a terms-of-agreement text corresponding to the action in a screen and an output of the terms-of-agreement text as sound guidance to prompt the user to decide whether to agree or disagree.

3. The agreement requiring action execution device according to claim 1,
wherein the agreement requiring action execution device is installed in a vehicle.

4. The agreement requiring action execution device according to claim 1,
wherein the agreement requiring action execution device is installed in the on-board device.

5. The agreement requiring action execution device according to claim 1,
wherein the agreement necessity determination section determines whether user agreement is required in order for the on-board device to execute the action by checking whether or not the criteria for agreement are satisfied based on the location of the vehicle or based on time and date.

6. The agreement requiring action execution device according to claim 1,
wherein the agreement requiring action is recording of data by a diagnostic recorder or a trip recorder.

7. The agreement requiring action execution device according to claim 1,
wherein the execution section prohibits execution of the action in the on-board device if the disagreement of the user is confirmed.

8. The agreement requiring action execution device according to claim 1,
wherein the agreement requiring action is an action that the on-board device is in the process of executing or an action that the on-board device is about to execute.

9. The agreement requiring action execution device according to claim 1,
further comprising a criteria change detection section that detects whether any of the criteria for agreement have been changed,
wherein, if the criteria change detection section detects that any of the criteria for agreement have been changed, the agreement necessity determination section determines whether agreement of the user is required in order for the on-board device to execute the action.

10. An agreement requiring action execution method to allow an on-board device to execute an action that requires agreement of the user to execute the action, the method comprising:
storing criteria for agreement that specify the conditions under which agreement of the user is required in order for the on-board device to execute the action;
checking the criteria for agreement to determine whether user agreement is required when the action is executed in the on-board device;
prompting the user to decide whether to agree or disagree if it is determined that user agreement is required in order for the on-board device to execute the action;
confirming the agreement or disagreement of the user; and
allowing continuation or initiation of the action executed in the on-board device when user agreement is confirmed.

11. An agreement requiring action execution method according to claim 10,
further comprising, when it is determined that user agreement is required in order for the on-board device to execute the action, performing at least one of a display of a terms-of-agreement text in a screen and an output of the terms-of-agreement text as sound guidance to prompt the user to decide whether to agree or disagree.

12. An agreement requiring action execution system that allows an on-board device to execute an action that requires agreement of the user to execute the action, the agreement requiring action execution system comprising:
an agreement requiring action execution device that is installed in a vehicle; and
a communication center that communicates with the agreement requiring action execution device;
wherein the communication center comprises:
a storage section that stores criteria for agreement, which specify the conditions under which agreement of the user is required in order for the on-board device to execute the action; and
a first communication section that communicates with the agreement requiring action execution device, and
the agreement requiring action execution device comprises:
a second communication section that communicates with the communication center;
an agreement necessity determination section that checks the criteria for agreement in the communication center, via the second communication section, to determine whether user agreement is required in order for the on-board device to execute the action;
an agreement prompt section that reads out a terms-of-agreement text corresponding to the action from the communication center, causes an on-board output device to perform at least one of a display of the terms-of-agreement text and an output of the terms-of-agreement text as sound guidance and that prompts the user to decide whether to agree or disagree, if it is determined that agreement of the user is required;
an agreement confirmation section that confirms the agreement or disagreement of the user via an on-board input device; and
an execution section that allows the action executed in the on-board device to continue or to initiate when user agreement is confirmed.

13. The agreement requiring action execution system according to claim 12, wherein the storage section in the communication center further comprises:
a database that stores criteria for agreement specifying the conditions under which user agreement is required in order for the on-board device to execute the action; and
a database that stores the user agreement history.

14. An agreement requiring action execution device that allows an on-board device to execute an action that requires agreement of the user to execute the action, the agreement requiring action execution device comprising:
a communication section that communicates with a communication center in which a criteria for agreement, which specify the conditions under which agreement of the user is required for the execution of the action in the on-board device, are stored and that receives a terms-of-agreement text corresponding to the action from the communication center when it is determined in the communication center that agreement is required;
an agreement prompt section that performs at least one of a display of the received terms-of agreement text on a screen and an output of the received terms-of-agreement text as sound guidance and prompts the user to decide whether to agree or disagree;
an agreement confirmation section that confirms the agreement or disagreement of the user; and
an execution section that allows the action executed by the on-board device to continue or to initiate when the user agreement is confirmed.
